(19) United States
(12) Patent Application Publication
(10) Pub. No.: US 2011/0165341 A1
(43) Pub. Date: Jul. 7, 2011

(54) BLOCK COPOLYMER-ASSISTED NANOLITHOGRAPHY

(75) Inventors: Chad A. Mirkin, Wilmette, IL (US); Jinan Chai, Evanston, IL (US); Fengwei Huo, Singapore (CN); Zijian Zheng, Hong Kong (CN); Louise R. Giam, Chicago, IL (US)

(73) Assignee: NORTHWESTERN UNIVERSITY, Evanston, IL (US)

(21) Appl. No.: 12/959,105

(22) Filed: Dec. 2, 2010

Related U.S. Application Data
(60) Provisional application No. 61/265,933, filed on Dec. 2, 2009.

(51) Int. Cl. B05D 5/00; B05D 1/28; B05D 3/10; B82Y 40/00; B82Y 99/00

(52) U.S. Cl. 427/535; 427/256; 977/892; 977/773

(57) ABSTRACT

In accordance with an embodiment of the disclosure, a method for forming submicron size nanostructures on a substrate surface includes contacting a substrate with a tip coated with an ink comprising a block copolymer matrix and a nanostructure precursor to form a printed feature comprising the block copolymer matrix and the nanostructure precursor on the substrate, and reducing the nanostructure precursor of the printed feature to form a nanostructure having a diameter (or line width) of less than 1 μm.

### CROSS-REFERENCE TO RELATED APPLICATION

The benefit under 35 U.S.C. §119(e) of U.S. Provisional Patent Application No. 61/265,933 filed Dec. 2, 2009, is hereby claimed, and its entire disclosure is incorporated herein by reference.

### STATEMENT OF GOVERNMENTAL INTEREST

The invention was made with government support under grant number N66001-08-1-2044 awarded by the Department of Defense, Defense Advanced Research Projects Agency (DARPA), grant number FA9550-08-1-0124 awarded by the Air Force Office of Scientific Research (AFOSR), and grant number EEC-0647560 awarded by the National Science Foundation Nanoscale Science and Engineering Center (NSF NSEC). The government has certain rights in this invention.

### BACKGROUND

1. Field of the Invention

The disclosure is generally directed to a patterning method, and more particularly, to a method of synthesizing and patterning nanostructures using block copolymer assisted nanolithography.

2. Brief Description of Related Technology

Nanoparticles exhibit size-dependent photonic, electronic, and chemical properties that could lead to a new generation of catalysts and nanodevices, including single electron transistors, photonics, and biomedical sensors. In order to realize many of these targeted applications, a way of synthesizing monodisperse particles while controlling individual particle position on technologically relevant surfaces is needed. The challenge of positioning or synthesizing single sub-10 nm nanoparticles in desired locations can be difficult, if not impossible, to achieve using currently available techniques including conventional photolithography. Current lithographic methods produce nanoparticle arrays through either lift-off processes or by prepatterning the surface chemically or geometrically to assist in the assembly of nanoparticles.

Although techniques such as electron beam (e-beam) lithography offer sub-50 nm resolution, fabricating sub-10 nm features can be difficult because of proximity effects resulting from electron beam-photoresist interactions. Additionally, the throughput of e-beam lithography is limited by its serial nature. Nanoimprint lithography and micro-contact printing, on the other hand, afford parallel patterning, but do not allow for arbitrary pattern formation. As scanning probe based methods, dip pen nanolithography (DPN) and polymer pen lithography (PPL) are particularly attractive because “inked” nanoscale tips can deliver material directly to a desired location on a substrate of interest with high registration and sub-50 nm feature resolution. These versatile techniques have been used to generate nanopatterns of alkanethiols, oligonucleotides, proteins, polymers, and inorganic materials on a wide variety of substrates. Previous attempts have been made to pattern nanoparticles directly by DPN, but the strong dependence of this technique on surface interactions, tip inking, and ink transport resulted in inhomogeneous features, whereas nanoparticle assembly via DPN-generated templates are inherently indirect and not ideal for positioning single objects with sub-10 nm dimensions. Because feature resolution is limited by the AFM tip radius of curvature and the water meniscus formed between tip and substrate, the ultimate resolution of DPN reported to date is 12 nm for an alkanethiol feature formed on crystalline Au (111) substrate, which was achieved by using an ultra sharp tip with a 2 nm radius.

In contrast with top-down approaches, the self-assembly of block copolymers offers a versatile platform, which affords feature sizes typically in the range of 5 nm to 100 nm, as dictated by the molecular weight of the block copolymers. The well-defined domain structures of the block copolymer system can be used as templates to achieve secondary patterns of functional materials including metals, semiconductors, and dielectrics. However, previous work described the use of block copolymers as thin film templates for the synthesis of nanoparticle arrays in mass, without control over individual particle position or dimensions. These phase separated domains often lack orientation and long-range order, preventing widespread use and adoption in technologically relevant applications. Attempts to improve ordering in block copolymer systems have been explored using external electric fields, shear and flow stresses, thermal gradients, solvent annealing, chemical prepatterning, and graphoepitaxy. Chemical prepatterning and graphoepitaxy provide more control over translational order and feature registration in patterns, but require additional indirect lithographic steps, such as e-beam lithography, which is expensive and low throughput for large area applications. Quasi-long range order of block copolymer microdomains on corrugated crystalline sapphire surfaces was obtained without the use of additional lithographic steps. This technique, however, is limited in the type of substrate that can be patterned and does not allow for positional control of the particles on arbitrary surfaces.

### SUMMARY OF THE INVENTION

In accordance with an embodiment of the disclosure, a method for forming sub-micron size nanostructures on a substrate surface includes contacting a substrate with a tip coated with an ink comprising a block copolymer matrix and a nanostructure precursor to form a printed feature comprising the block copolymer matrix and the nanostructure precursor on the substrate, and reducing the nanostructure precursor of the printed feature to form a nanostructure having a diameter (or line width) of less than 1 μm.

In accordance with an embodiment of the disclosure, a method for forming a sub-micron sized nanoparticle on a substrate surface, includes contacting a substrate with a tip coated with an ink comprising PEO-b-P2VP and a metal salt to form a printed feature comprising a micelle comprising the PEO-b-P2VP and containing the metal salt, and reducing the metal salt of the printed feature to form a nanoparticle having a diameter of less than 1 μm.

### BRIEF DESCRIPTION OF THE DRAWINGS

FIG. 1A is a schematic drawing illustrating the structure and molecular weight of PEO-b-P2VP;

FIG. 1B is a schematic drawing of a method of forming nanostructures in accordance with an embodiment of the disclosure;

FIG. 1C is an atomic force microscopy (AFM) topographical image of a square dot array of PEO-b-P2VP/AuCl₄⁻ ink deposited on a Si/SiOₓ substrate by dip pen nanolithography using a method of forming nanostructures in accordance with an embodiment of the disclosure;

FIG. 1D is a graph showing the height profile of one line of PEO-b-P2VP/AuCl₄⁻ dots from FIG. 1C, illustrating the uniformity of the feature size;

FIG. 1E is a scanning electron microscopy (SEM) image of sub-10 nm Au nanoparticles produced by plasma treatment of the square dot array of FIG. 1C. The inset is a Fourier transform of the SEM image;

FIG. 1F is a high resolution transmission electron microscopy (TEM) image of a crystalline Au nanoparticle formed by a method in accordance with the disclosure, illustrating that the nanoparticle has a diameter of 8 nm and the crystal has an interplanar spacing of 0.24 nm. The inset is a typical electron diffraction pattern of the Au (111) nanoparticle;

FIG. 2A is a TEM image of PEO-b-P2VP/AuCl₄⁻ micelles prepared by dropping the solution on a carbon-coated copper grid;

FIG. 2B is a TEM image of Au nanoparticles formed within the polymer matrix after DPN patterning using a method in accordance with an embodiment of the disclosure;

FIG. 3 is an X-ray photoelectron spectroscopy spectra of Au nanoparticles formed by a method in accordance with an embodiment of the disclosure using a PEO-b-P2VP/HAuCl₄ ink;

FIG. 4A is an SEM image of a large array of single Au nanoparticles formed by a method in accordance with an embodiment of the disclosure;

FIG. 4B is a graph illustrating a registry analysis of the array of 400 particle features over different areas, with the distribution error being defined as the ratio of the distance of the particles away from the center of the block copolymer feature to the feature diameter;

FIG. 5A is an AFM topographical image of a 5×5 dot pattern of a PEO-b-P2VP/AuCl₄⁻ ink with different sizes deposited on a Si/SiOₓ substrate generated by a method in accordance with an embodiment of the disclosure in which the tip-substrate contact time was intentionally increased. The tip-substrate contact time from bottom to top of the image is 0.01, 0.09, 0.25, 0.49, and 0.81 seconds;

FIG. 5B is a graph showing the height profile of one line of PEO-b-P2VP/AuCl₄⁻ dots of FIG. 5A, demonstrating the time-dependent polymer transport volume;

FIG. 5C is an SEM image of Au particles (bright dots) with different sizes formed within the block copolymer matrix (dark circles) after brief plasma exposure of the PEO-b-P2VP/AuCl₄⁻ dots of FIG. 5A;

FIG. 5D is a scanning TEM image of the pattern of FIG. 5A, confirming the formation of single Au nanoparticles (black dot) within the block copolymer matrix (grey surrounding dot);

FIG. 5E is a graph illustrating the size distribution of the PEO-b-P2VP/AuCl₄⁻ dots of FIG. 5A and the size distribution of the corresponding Au nanoparticles formed by reduction of the PEO-b-P2VP/AuCl₄⁻ dots of FIG. 5A;

FIG. 6 is a scanning TEM image of a 5×5 dot array of PEO-b-P2VP/AuCl₄⁻ dots with different sizes formed on a Si₃N₄ substrate generated by a method in accordance with an embodiment of the disclosure in which the tip-substrate contact time was intentionally increased. The tip-substrate contact time from bottom to top of FIG. 6 is 1, 4, 9, 16, and 25 seconds. Single Au nanoparticles (bright white spot) fowled within the block copolymer matrix (gray surrounding) except in the circled features where two nanoparticles were found;

FIG. 7A is a dark field optical microscopy image of the Northwestern University Wildcat logo pattern made of individual PEO-b-P2VP/AuCl₄⁻ dots features formed by a method in accordance with an embodiment of the disclosure;

FIG. 7B is an SEM image of a magnified portion of FIG. 7A showing the formation of a Au nanoparticle arrays embedded in the block copolymer matrix upon plasma exposure. The inset is a magnified SEM image of a single gold nanoparticle after polymer removal;

FIG. 8A is an SEM image of a 3×3 array of Au nanoparticles having sub-5 nm diameters formed in by a method in accordance with an embodiment of the disclosure;

FIG. 8B is scanning TEM images of the individual Au nanoparticles of FIG. 8A, showing the size of the nanoparticles;

FIG. 8C is a histogram showing the size distribution of the sub-5 nm Au nanoparticles of FIG. 8A;

FIG. 9A is a dark field optical microscopy image of a large scale pattern of PEO-b-P2VP/AuCl₄⁻ dots formed by polymer pen lithography (15,000 pen array) on a Si/SiOₓ substrate using a method in accordance with an embodiment of the disclosure. The inset shows a 20×20 dot array with 2 μm spacing for each pattern formed by an individual pen of the pen array;

FIG. 9B is an SEM image of Au particles (bright dot) formed within the patterned array of FIG. 9A after the block copolymer matrix was removed by oxygen plasma. The inset shows a single Au nanoparticle has a diameter of 9.5 nm; and

FIG. 10 is an SEM image of sub-5 nm Pt nanoparticles formed in a PEO-b-P2VP block copolymer matrix by dip pen nanolithography using a method in accordance with an embodiment of the disclosure.

### DETAILED DESCRIPTION

Scanning Probe Block Copolymer Lithography can allow for patterning of sub-10 nm size single nanostructures, for example, nanoparticles, while enabling one to control the growth and position of individual nanostructures in situ. In accordance with embodiments of the disclosure, the scanning probe block copolymer lithography method can utilize dip-pen nanolithography or polymer pen lithography printing methods to transfer phase-separating block copolymer-nanostructure precursor inks to a substrate. After patterning, nanostructure formation can be induced by reduction of the nanostructure precursor in the printed features and removal of the block copolymer matrix. The printed features and accordingly the formation of the nanostructures can be arranged in any arbitrary pattern using the method of the disclosure. Any nanostructure having any shape can be formed by the method of the disclosure. The nanostructures can be, for example, nanoparticles or nanowires.

Advantageously, methods in accordance with embodiments of the disclosure can allow for in situ synthesis of nanostructures having a size 10 or more times smaller than the originally printed features. For example, the printed features, which include the block-copolymer matrix and the nanostructure precursor, can have a diameter or line width of about 20 nm to about 1000 nm, about 40 nm to about 800nm, about 60 nm to about 600 nm, about 80 nm to about 400 nm, or about 100 nm to about 200 nm. Other suitable printed feature diameters or line widths include about 20, 30, 40, 50, 60, 70, 80, 90, 100, 110, 120, 130, 140, 150, 160, 170, 180, 190, 200, 220, 240, 260, 280, 300, 320, 340, 360, 380, 400, 420, 440, 460, 480, 500, 520, 540, 560, 580, 600, 620, 640, 660, 680, 700, 720, 740, 760, 780, 800, 820, 840, 860, 880, 900, 920, 940, 960, 980, and 1000 nm. The resulting nanostructures can have a diameter or line width of about 1 nm to about 100 nm, about 1 nm to about 25 nm, about 2 nm to about 20 nm, about 4 nm to about 15 nm, about 6 nm to about 10 nm, about 50 nm to about 80 nm, or about 40 nm to about 60 nm. Other suitable nanostructure diameters or line widths include, for example, about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, and 100 nm.

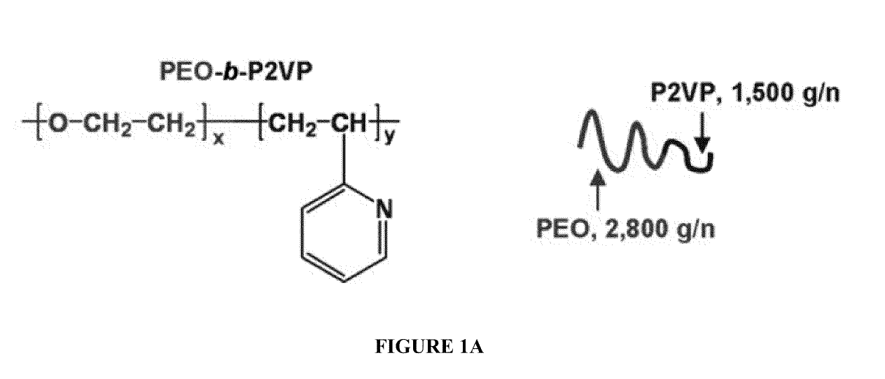

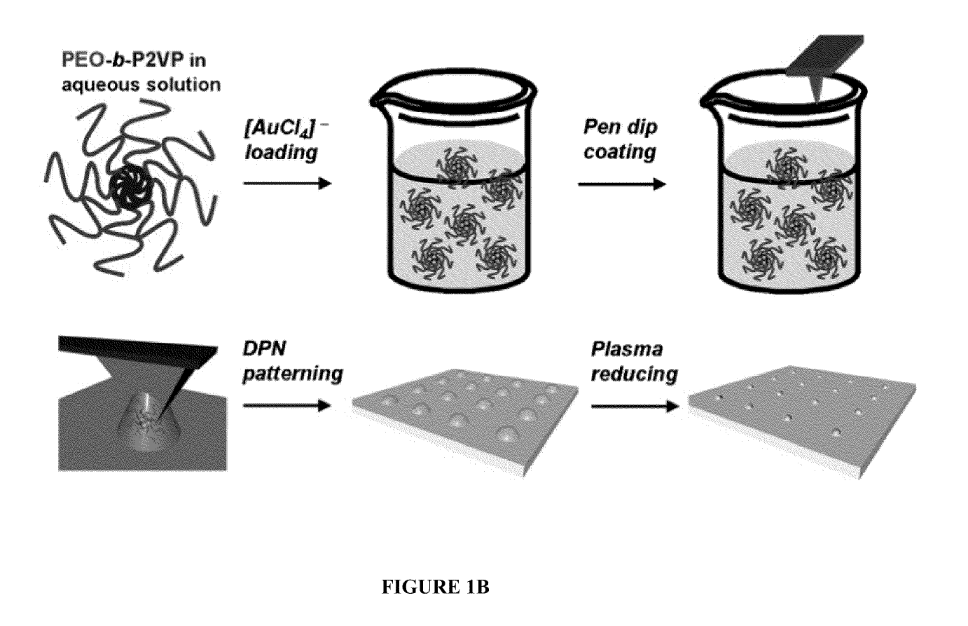

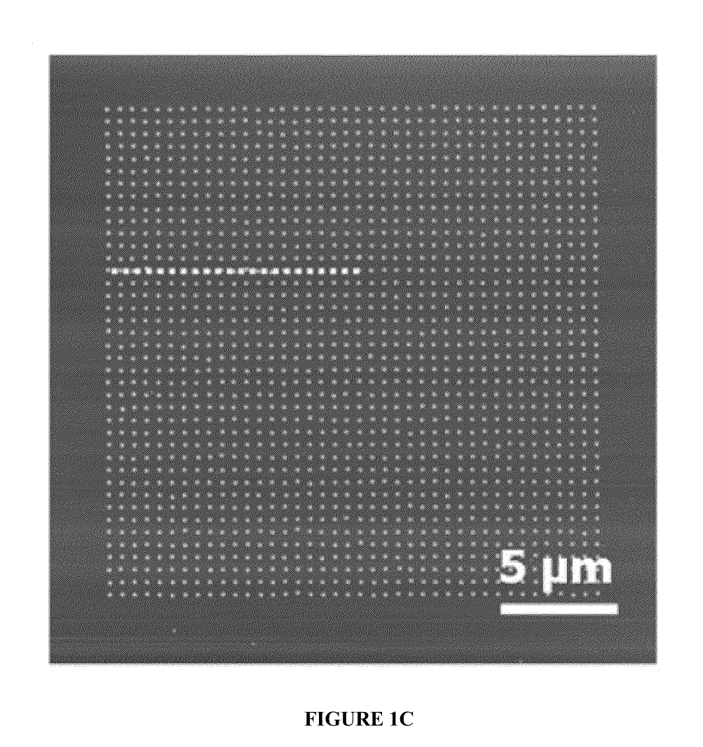

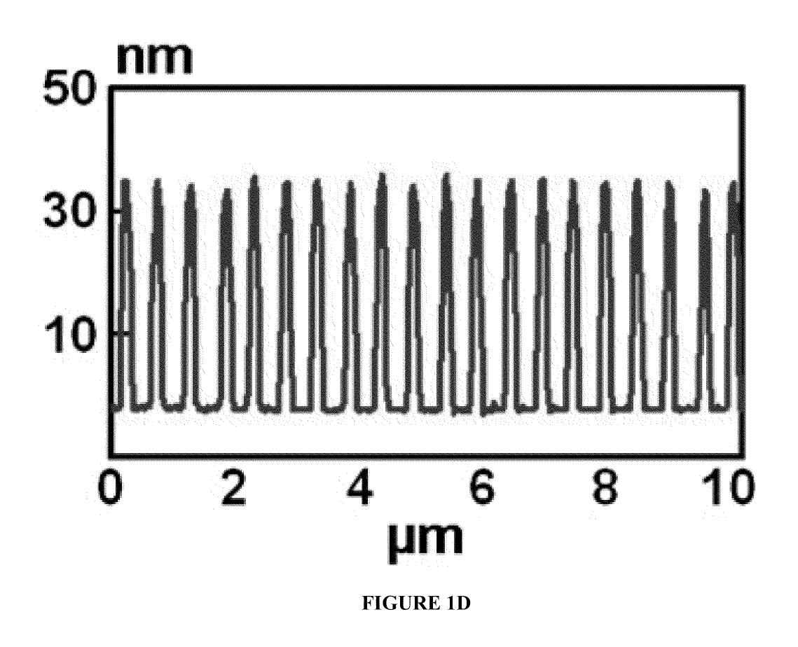

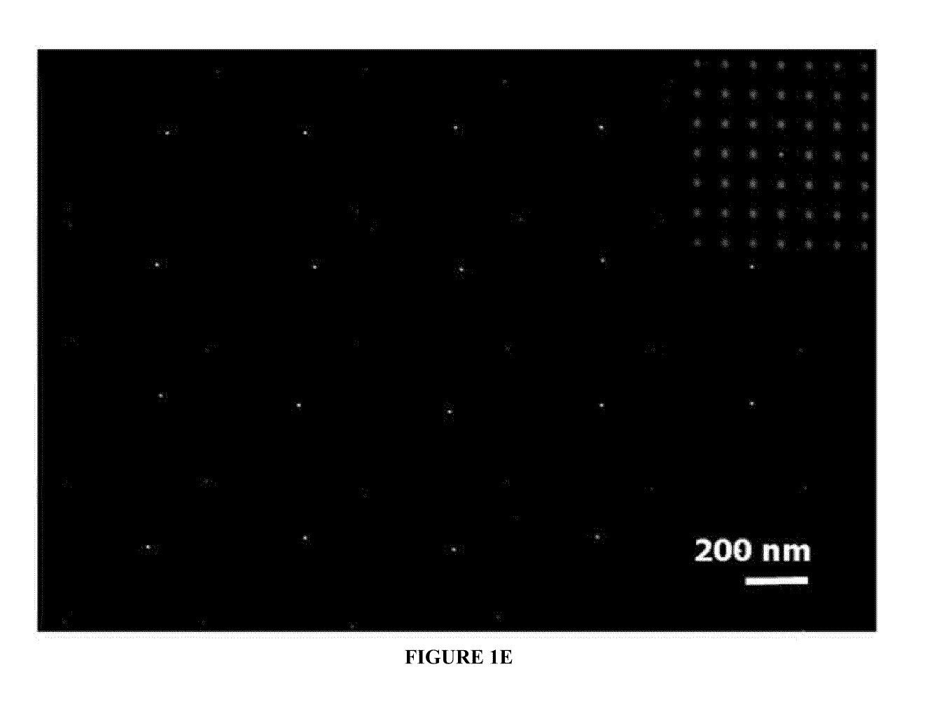

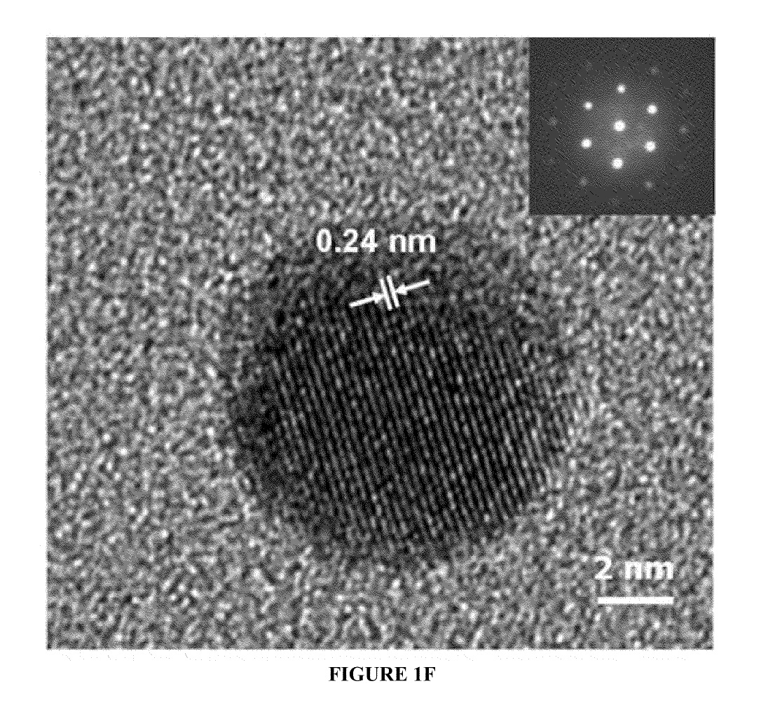

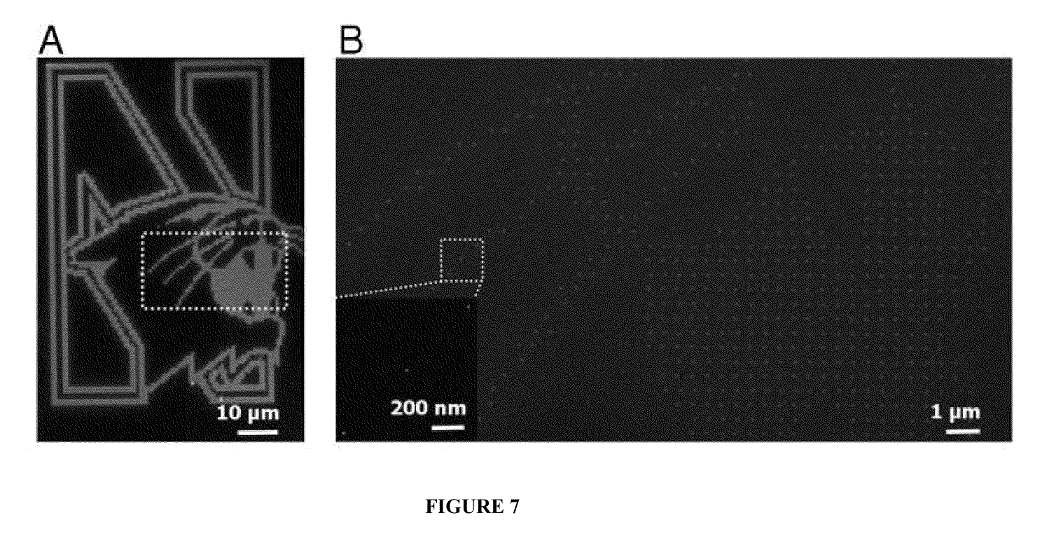

Referring to FIG. 1B, a method of forming nanostructures can include loading a tip with the ink that includes a block copolymer matrix and a nanostructure precursor. FIG. 1B illustrates the use of a dip-pen nanolithography (DPN) tip for patterning. However, other tip-based lithography methods, such as polymer pen lithography (PPL) and gel pen lithography, can be used. The coated tip is then brought into contact with a substrate to deposit the ink on the substrate in the form of printed features. The printed features include the block copolymer matrix and the nanostructure precursor contained in the block copolymer matrix. The nanostructure precursor in the printed features can then be reduced to form the nanostructures and block copolymer matrix can be removed. Referring to FIGS. 7A and 7B, embodiments of the method of the disclosure can allow for arbitrary pattern control of single nanostructures, for example, nanoparticles, by patterning with tip-based patterning methods such as DPN and PPL.

The block copolymer material should be selected so as to be capable of transferring from a scanning probe tip to a substrate in a controllable way and sequestering the nanostructure precursor. Suitable block copolymer materials include, for example, poly(ethylene oxide)-b-poly(2-vinylpyridine) (PEO-b-P2VP), PEO-b-P4VP, and PEO-b-PAA. FIG. 1A illustrates the PEO-b-P2VP block copolymer. When using a PEO-b-P2VP block copolymer, the P2VP is responsible for concentrating the nanostructure precursor, while the PEO acts as a delivery block to facilitate ink transport. The block copolymer separates into nanoscale micelles, which not only localizes the nanostructure precursor, but also cause the amount of nanostructure precursor in each feature to be substantially lower than if the feature was made from pure metal ion ink.

The molar ratio of the nanostructure concentrating or precursor-coordinating block to the nanostructure precursor can be about 1:0.1 to about 64: 1, about 1:0.1 to about 10:1, about 1:0.5 to about 8:1, about 1:1: to about 10:1, about 2:1 to about 8:1, about 4:1 to about 6:1, about 10:1 to about 64:1, about 15:1 to about 60:1, or about 30:1 to about 40:1. Other suitable molar ratios include about 1:0.1, 1:0.2, 1:0.25, 1:0.3, 1:0.4, 1:0.5, 1:0.6, 1:0.7, 1:0.8, 1:0.9, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 22:1, 24:1, 26:1, 28:1, 30:1, 32:1, 34:1, 36:1, 38:1, 40:1, 42:1, 44:1, 46:1, 48:1, 50:1, 52:1, 54:1, 56:1, 58:1, 60:1, 62:1, and 64:1.

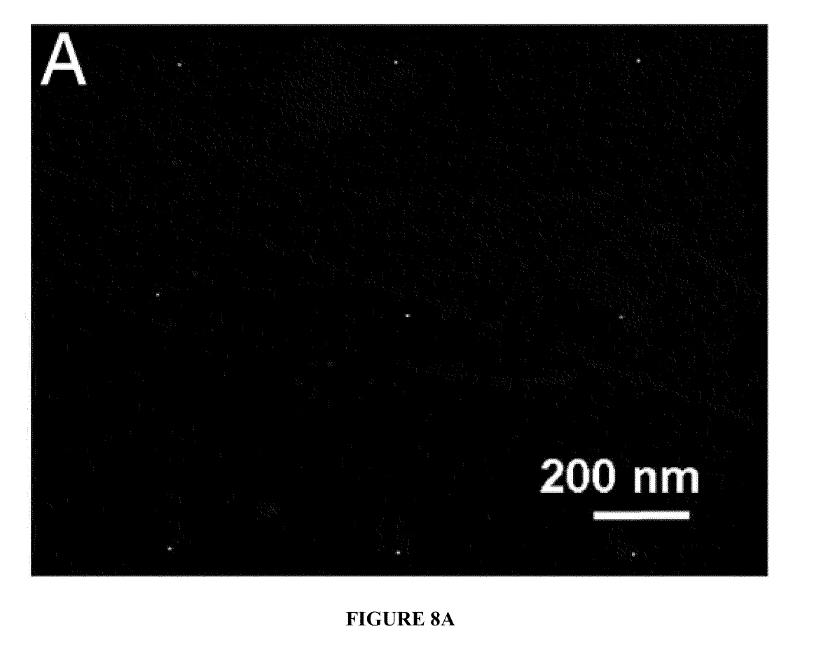

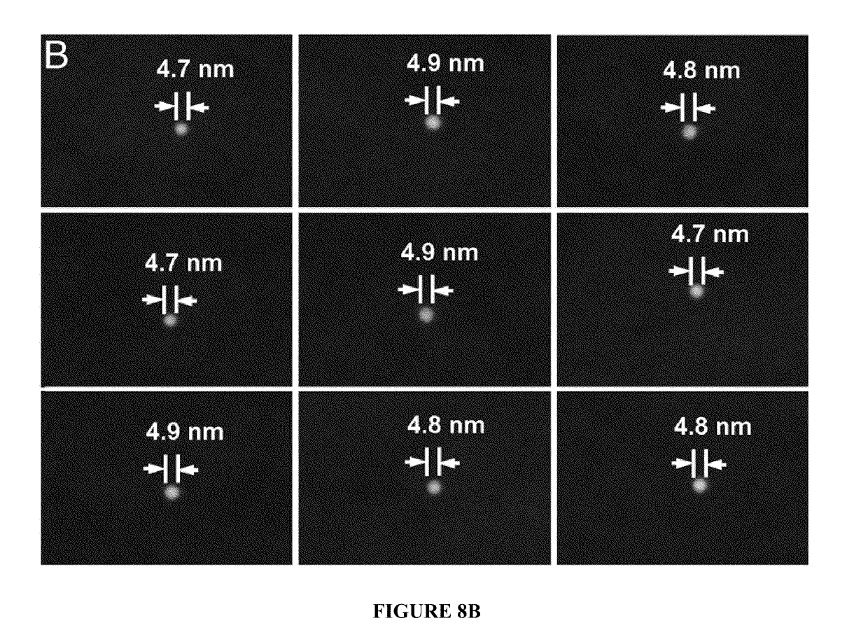

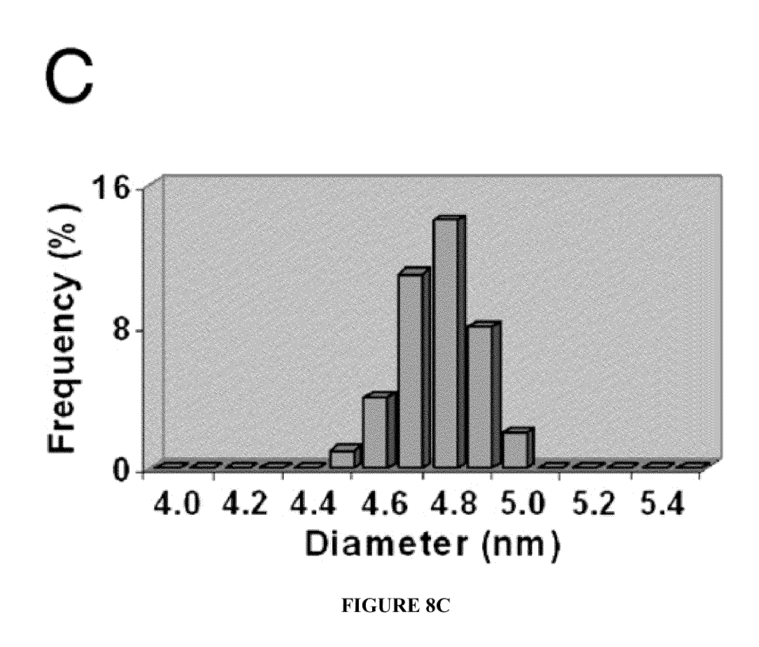

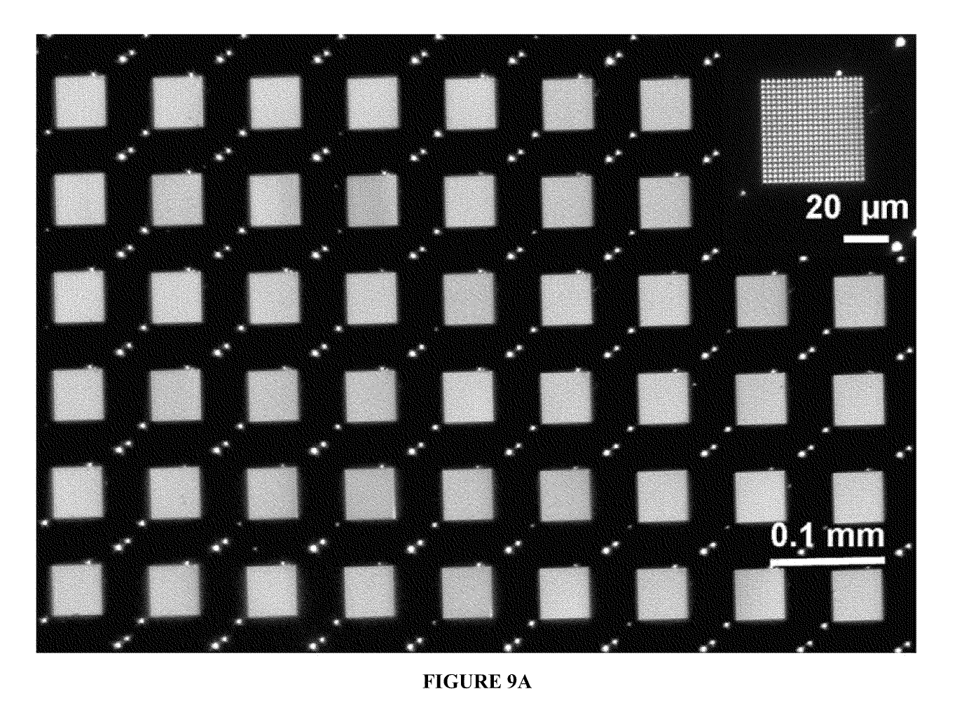

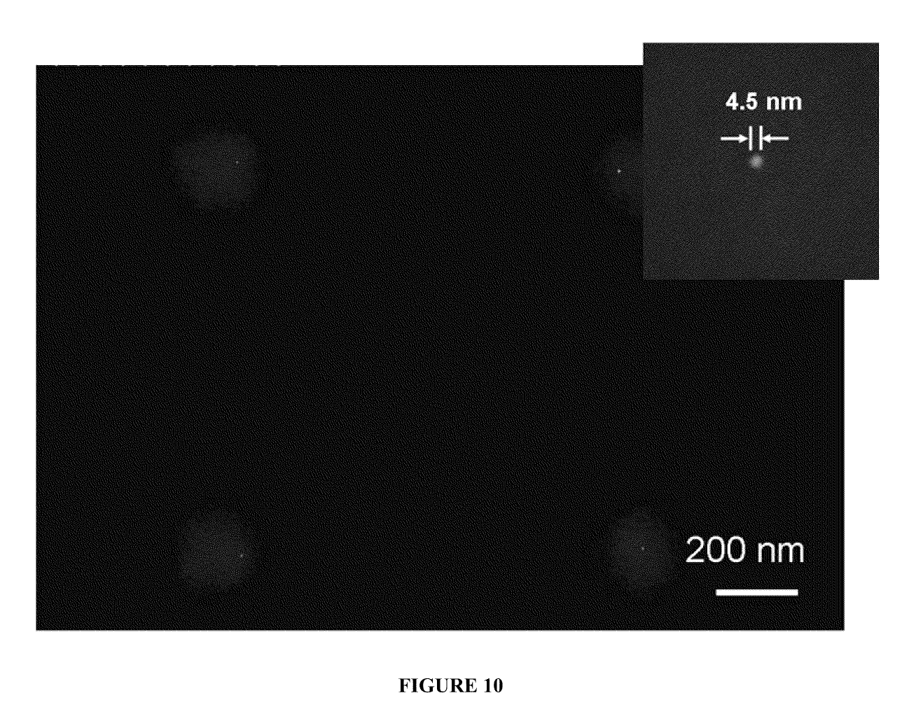

The nanostructure precursor can be, for example, any precursor material suitable for forming a metal nanostructure, a semiconductor nanostructure, or a dielectric nanostructure. For example, the nanostructure precursor can be a metal salt, such as, HAuCl₄, Na₂PtCl₄, CdCl₂, ZnCl₂, FeCl₃, NiCl₂, and other inorganic compounds. FIG. 8A illustrates a pattern of Au nanoparticles formed by a method in accordance with an embodiment of the disclosure using the metal salt HAuCl₄ and the block copolymer PEO-b-P2VP. FIG. 10 illustrates a pattern of Pt nanoparticles formed by a method in accordance with an embodiment of the disclosure using the metal salt Na₂PtCl₄ and the block copolymer PEO-b-P2VP, with the molar ratio of P2VP to Pt being 1 to 0.25.

In one embodiment, the nanostructure precursor is HAuCl₄ and the block copolymer is PEO-b-P2VP. The protonated pyridine units have a strong affinity to AuCl₄⁻ moieties because of electrostatic interactions, while the PEO block enables good transport properties in DPN experiments. Referring to FIG. 1B, when the block copolymer and the nanostructure precursor are mixed in an aqueous solution, micelles with a water insoluble P2VP core surrounded by a PEO corona form, confining the AuCl₄⁻ to the P2VP core.

The block copolymer-nanostructure precursor ink can be printed on any suitable substrate, including, for example, Si/SiOₓ substrates, Si₃N₄ membranes, glassy carbon, and Au substrates.

After patterning, the nanostructures are formed by reduction of the nanostructure precursor in the printed features. The reducing agent can be any suitable agent for transforming the nanostructure precursor to a nanostructure. Subsequent reduction of the patterned block copolymer-nanostructure precursor micelles results in formation of nanostructures within the aggregated micelles. For example, oxygen or argon plasma can be used as the reducing agent and to remove the block copolymer. Reduction of the nanostructure precursor material by oxygen plasma can be facilitated by hydrocarbon oxidation. Other suitable reducing agents include, for example, gases such as H₂. The reducing agent can also be used to remove the block copolymer after formation of the nanostructures.

The size of the nanostructures synthesized by a method in accordance with embodiments of the disclosure can be controlled, for example, by controlling the chain length of the copolymer block, the loading concentration of the nanostructure precursor, and the type of reducing agent. For example, increasing the loading concentration of the nanostructure precursor results in nanostructures having an increased size. Additionally, without intending to be bound by theory, it is believed that increasing the molecular weight of the copolymer block results in a larger micelle cores, and hence, larger nanostructures. The nanostructure precursor determines the local concentration of ions within the polymer micelle. The lower the concentration, the small the synthesized nanostructures. For example, referring to FIG. 8B, sub-5 nm nanoparticles can be fowled by using a salt-copolymer mixture having a molar ratio of nanoparticle concentrating block to nanoparticle precursor of about 4 to 1.

The dwell time (also referred to herein as the tip-substrate contact time) during patterning of the block copolymer-nanostructure precursor inks can be about 0.01 seconds to about 30 seconds, about 0.01 second to about 10 seconds, about 0.05 seconds to about 8 seconds, about 0.1 seconds to about 6 seconds, about 0.5 seconds to about 4 seconds, about 1 second to about 2 seconds, about 10 seconds to about 30 seconds, about 8 seconds to about 26 seconds, about 6 seconds to about 24 seconds, about 15 seconds to about 20 seconds, or about 10 seconds to about 15 seconds. Other suitable dwell times includes, for example, about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, and 30 seconds.

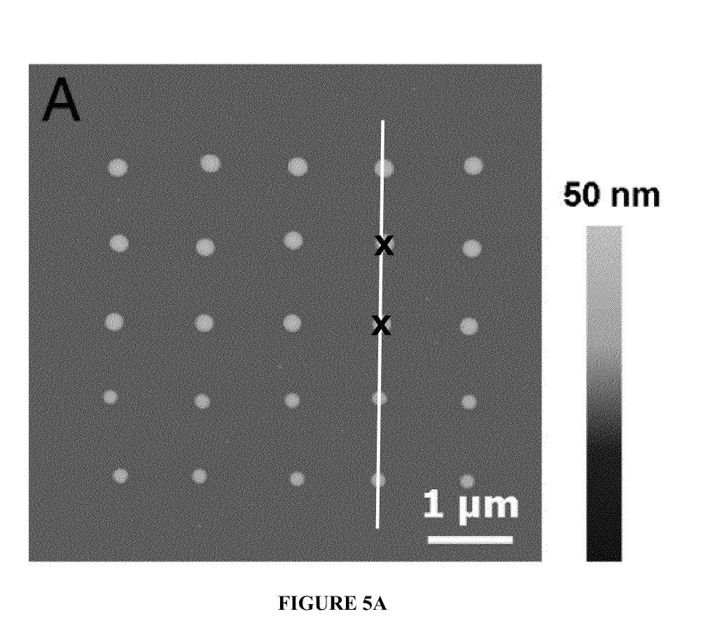

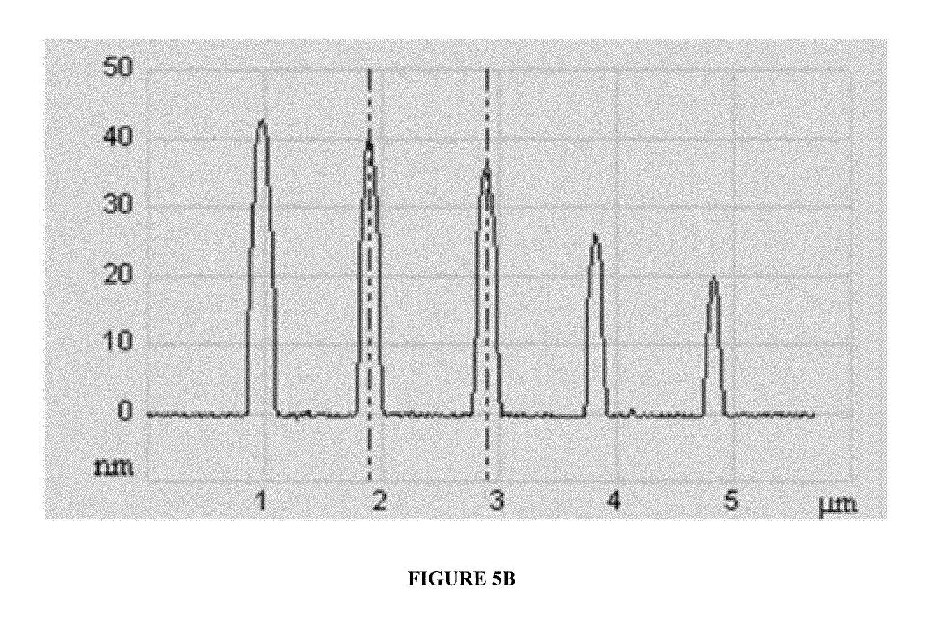

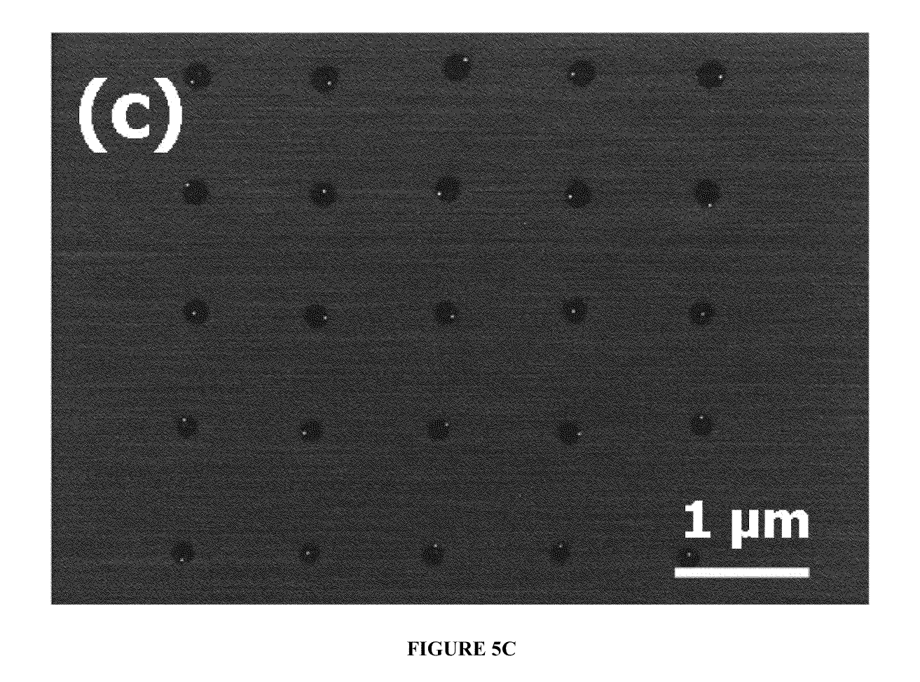

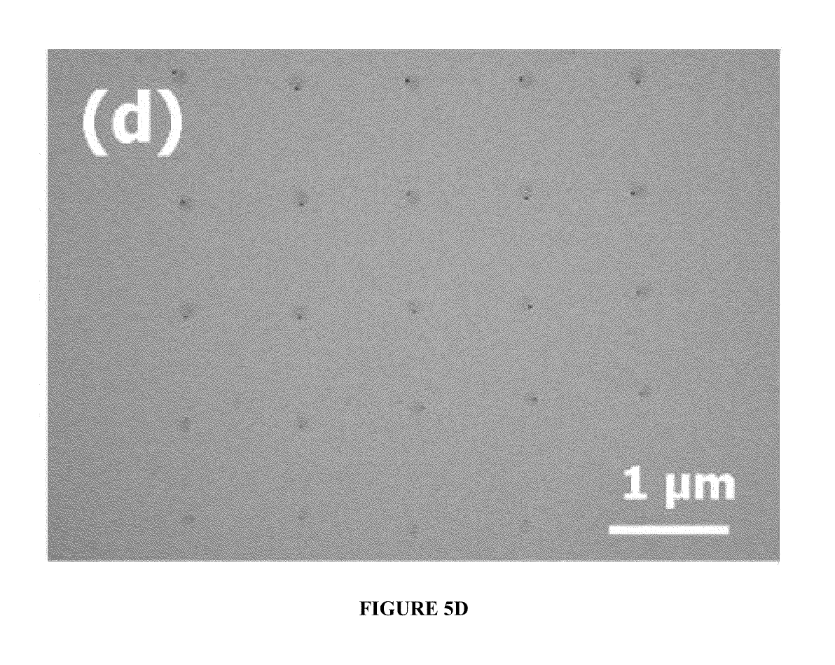

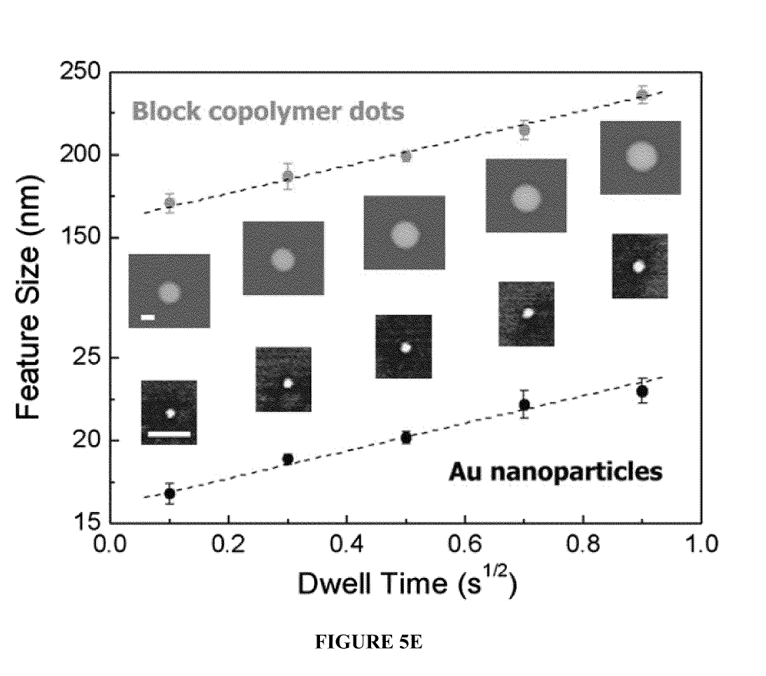

The size of the nanostructures synthesized by a method in accordance with embodiments of the disclosure can also be controlled by varying the dwell time when patterning by DPN or polymer pen lithography methods. The feature size dependence on tip-substrate contact time (dwell time) exhibited when using DPN or polymer pen lithography methods can be used to control both the size of the printed feature (having the block copolymer and the nanostructure precursor) and the size of the resulting nanostructure. Referring to FIG. 5E, for example, nanostructures synthesized using a method in accordance with embodiments of the disclosure and patterned by DPN can have a diameter that is linearly dependent on the square root of the tip-substrate contact time (dwell time).

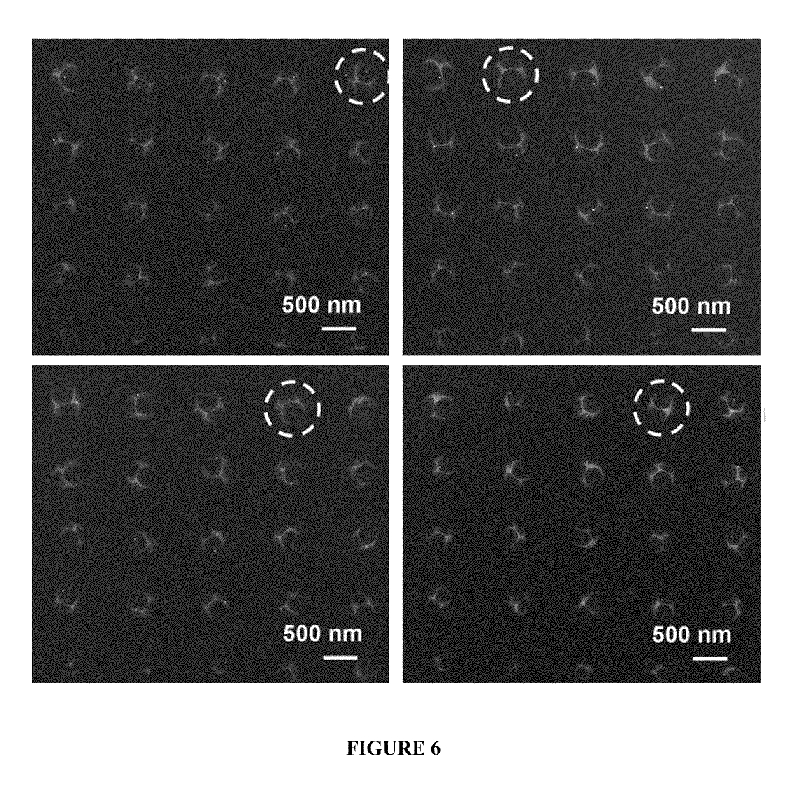

Without intending to be bound by theory, it is believed that the number of nanostructures, for example, nanoparticles formed within a block copolymer printed feature can be controlled by controlling the size of the block copolymer-nanostructure precursor printed feature. For example, referring to FIG. 6, multiple nanoparticles can be formed within a block copolymer matrix, when the block copolymer patterned feature has a diameter of 450 nm or greater.

### EXAMPLES

### Example 1

### Patterning Using Dip Pen Nanolithography

PEO-b-P2VP was dissolved in an aqueous solution at a concentration of 0.5% w/w. The PEO had a molecular weight of 2.8 kg/mol, and the PVP had a molecular weight of 1.5 kg/mol. HAuCl₄.3H₂O was added to the solution at a 2:1 molar ratio of P2VP to Au. The copolymer-gold salt solution was stirred for 24 hours. A DPN twelve pen tip array (available from Nanolnk, Skokie, Ill.) was dipped into the ink solution and then dried with nitrogen. The DPN experiment was performed on an Nscriptor system (Nanolnk) equipped with a 90 μm closed loop scanner and commercial lithography software. The ink tips were brought in contact with a hexamethyldisilazane (HDMS) coated Si/SiOₓ surface. Dots of uniform size were produced with a tip dwell time of 0.01 s at 70% relative humidity. Facile transport of PEO under high humidity environments allows for rapid deposition of PEO-b-P2VP. The process was repeated 1600 times for a total patterning time of less than about 2 minutes to generate a 40 by 40 array of dot features, as shown in FIG. 1C. The distance between features was 500 nm. In a representative 20-dot line generated by a single pen, each feature diameter was approximately 90 nm with a size deviation below 10%, as measured by AFM topography (FIG. 1D).

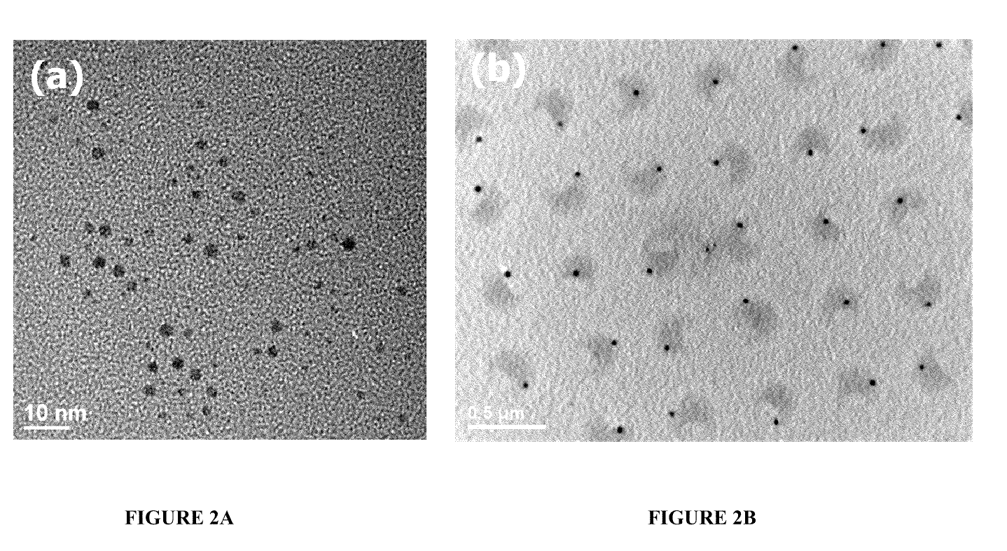

Referring to FIG. 2A, the incorporation of AuCl₄⁻ in the polymer micelle cores provided enough Z-contrast for observation by transmission electron microscopy (TEM), revealing the existence of spherical micelles in a bulk aqueous solution. The spherical micelles had a diameter of about 2 nm. When the PEO-b-P2VP/AuCl₄⁻ inked pen array was brought in contact with the sample surface, micelles were transported to the substrate through the meniscus formed at the tip end, wherein interactions take place between the pyridine units due to tip-induced higher local concentration of the block copolymers, resulting in the coalescence of multiple micelles loaded with AuCl₄⁻ ions, as shown in FIG. 2B.

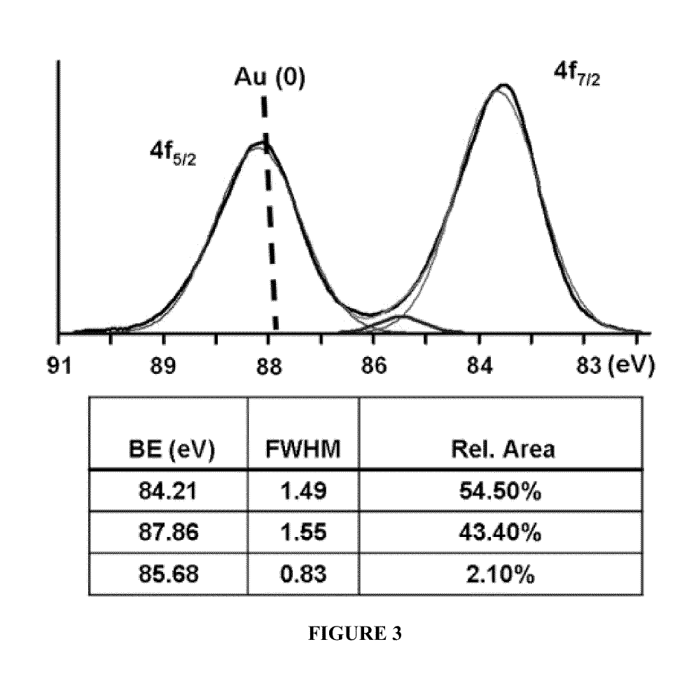

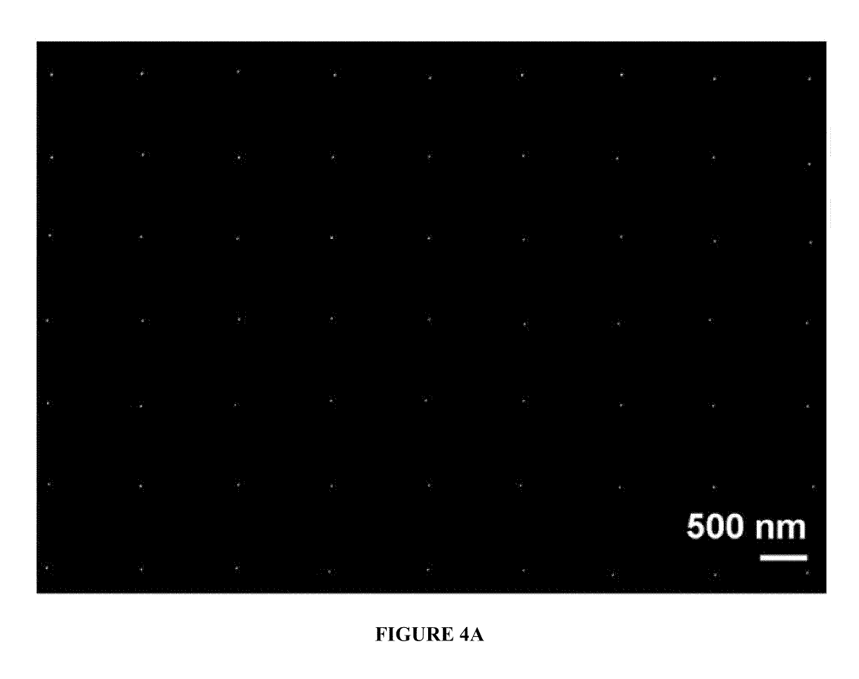

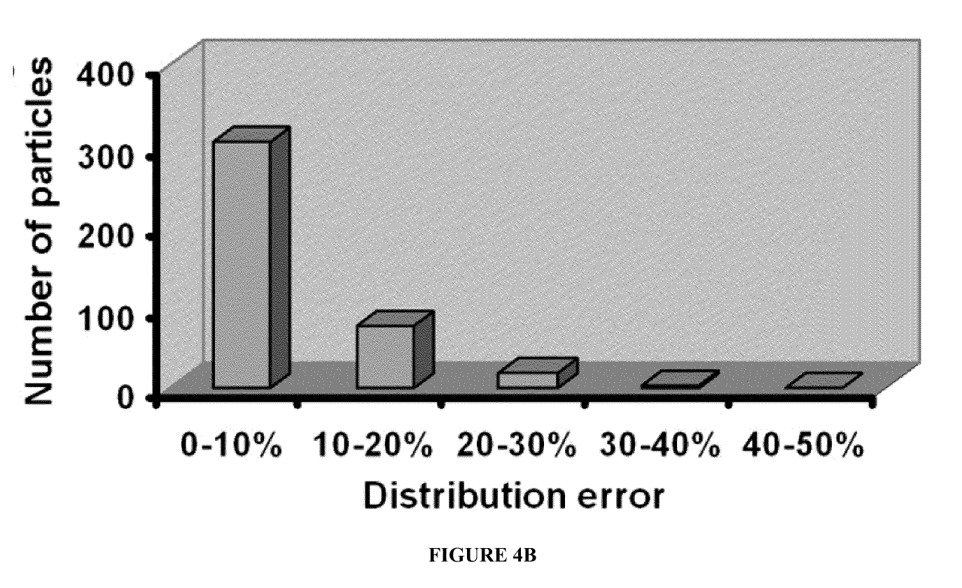

Referring to FIG. 3, the pattern was then reduced by oxygen plasma, resulting in the formation of Au nanoparticles within the aggregated micelles. The surrounding polymer matrix was removed by the oxygen plasma, leaving square arrays of sub-10 nm Au nanoparticles on the Si substrate (FIG. 1E). Referring to FIG. 4A, scanning electron microscopy indicated that the method achieved 100% yield of single Au nanoparticles per spot in the 11×8 array. FIG. 4B is a registry analysis of 400 particle features over different areas of the formed pattern. The distribution error is defined as the ratio of the distance of the particle away from the center of the block copolymer feature to the feature diameter.

The PEO-b-P2VP/AuCl₄⁻ ink was also patterned on a 50 nm Si₃N₄ TEM membrane followed by oxygen plasma reduction. Referring to FIG. 1F, TEM images revealed that the mean diameter of the Au nanoparticles in the array was 8.2 nm±0.6 nm. The clear lattice fringes with an interplanar spacing of 0.24 nm corresponding to the (111) plane in face-centered-cubic Au. The spherical Au nanoparticles were highly crystalline. The characteristic electron diffraction pattern also confirmed the single crystal nature of the Au nanoparticles (see inset of FIG. 1F).

### Example 2

### Varying the Feature Size

The time-dependent ink transport characteristics of DPN provide a facile route for controlling the size of the nanomaterials synthesized within the deposited block copolymer nanoreactors. It was observed that the diffusive characteristics of the block copolymer ink are similar to previous reports of feature size dependence on tip-substrate contact time. It is believed that the nanoparticles synthesized using this DPN-based approach have dimensions that are linearly dependent on the square root of the tip-substrate contact time.

Referring to FIG. 5A, DPN was used to produce Au nanoparticles of different diameters in an environment of saturated humidity. Tip dwell times of 0.01, 0.9, 0.25, 0.49, and 0.81 seconds were used to generate the nanoparticles. The Au nanoparticles of various sizes without removal of the block copolymer matrix were confirmed by SEM and TEM images, as shown in FIGS. 5C, and 5D. The dimensional variation in the spot sizes deposited by DPN was measured by the height profile in topographical AMF (FIG. 5B) and are graphically summarized in FIG. 5E. The spot sizes increased from about 170 nm to about 240 nm as the dwell time increased from 0.01 seconds to 0.81 seconds, following the linear growth rate and square root dependence. Referring to FIG. 5E, an increase in the diameter of the Au particles of from about 16 nm to about 24 nm was observed with increasing tip dwell time. Within the range of dwell times performed, a near linear relation between the dot size of the parent block copolymer matrix and the diameter of the synthesized Au nanoparticle at a fixed ratio of about 10. This demonstrates that the DPN-generated nanoparticles can have a dimension ten times smaller than that of the directly patterned original material, which is a significant advantage of embodiments of the method of the disclosure.

Referring to FIG. 6, Au nanoparticles were also synthesized with varying features using a PEO-b-P2VP/HAuCl₄ ink by varying the dwell time. The features were patterned on Si₃N₄ substrates using DPN with dwell times of 25, 16, 9, 4, and 1 second (from the top to bottom of FIG. 6). After reduction with oxygen plasma, single Au nanoparticles were formed within the block copolymer matrix. The circled features of FIG. 6 illustrate features wherein multiple Au nanoparticles formed. Without intending to be bound by theory, it is believed that when the block copolymer features are large enough (for example, about 450 nm in diameter), more than one Au nanoparticle can form within the original printed feature.

### Example 3

### Patterning of Sub-5 nm Au Nanoparticles

Sub-5 nm Au nanoparticles were synthesized by decreasing the salt concentration while using the same block copolymer as the synthetic nanoreactor. HAuCl₄ was added to the PEO-b-P2VP micelle solution to obtain a 4:1 molar ratio of 2-vinylpyridine to gold. After stirring for one day, a pen array was loaded with the block copolymer-gold salt ink. The ink was then patterned on a Si₃N₄ membrane, followed by oxygen plasma exposure for Au reduction. Referring to FIG. 8A, SEM images illustrated the formation of an array of Au nanoparticles having sub-5 nm diameters. The size of the Au nanoparticles was measured using the Z-contrast TEM image shown in FIG. 8C. Referring to FIG. 8B, the average diameter of the Au nanoparticles was 4.8 nm±0.2 nm, a 4% variation.

### Example 4

### Patterning Using Polymer Pen Lithography

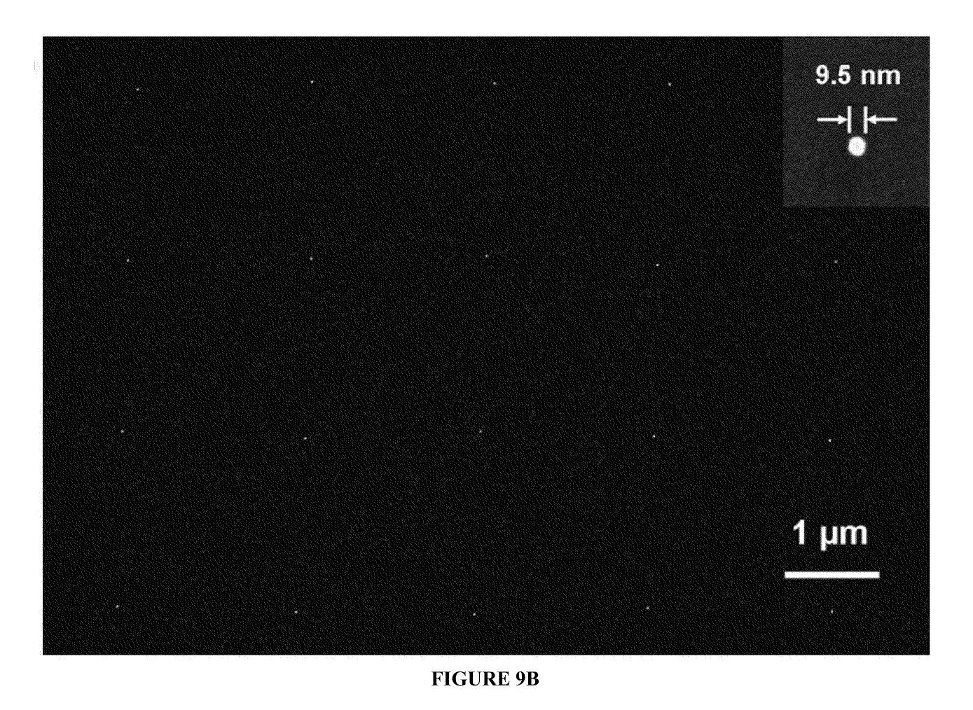

A 1 cm² polymer pen array (about 15,000 PDMS pens) with 80 μm spacing between tips was inked with the PEO-b-P2VP/AuCl₄⁻ ink by spin coating at a rate of 2000 rpm for 2 min. Using a Park AFM platform (XEP, Park Systems Co., Suwon, Korea) at 80% humidity, each pen in the PPL array was used to make a 20×20 dot array with 2 m spacing between the dots (FIG. 9A). The deposition time for each dot was 0.5 seconds. Thus, an array of approximately 25 million dots (400 dots/pen) was generated in less than 5 minutes. Referring to FIG. 9B, the block copolymer matrix was removed by oxygen plasma, resulting in the formation of an array of single Au nanoparticles.

The foregoing describes and exemplifies aspects of the invention but is not intended to limit the invention defined by the claims which follow. All of the methods disclosed and claimed herein can be made and executed without undue experimentation in light of the present disclosure. While the materials and methods of this invention have been described in terms of specific embodiments, it will be apparent to those of skill in the art that variations may be applied to the materials and/or methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved.

All patents, publications and references cited herein are hereby fully incorporated by reference. In case of conflict between the present disclosure and incorporated patents, publications and references, the present disclosure should control.

1. A method for forming a sub-micron sized nanostructure on a substrate surface, comprising:
contacting a substrate with a tip coated with an ink comprising a block copolymer and a nanostructure precursor to form a printed feature comprising the block copolymer and the nanostructure precursor on the substrate; and
reducing the nanostructure precursor of the printed feature to form a nanostructure having a diameter (or line width) of less than 1 μm.

2. The method of claim 1, wherein the nanostructure has a diameter (or line width) of less than 10 nm.

3. The method of any one of claims 1, wherein the nanostructure has a diameter (or line width) of less than 5 nm.

4. The method of claim 1, wherein the block copolymer matrix is selected from the group consisting of PEO-b-P2VP, PEO-b-P4VP, and PEO-b-PAA.

5. The method of claim 1, wherein the block copolymer comprises a first polymer for concentrating the nanostructure precursor and a second polymer to facilitate ink transport.

6. The method of claim 1, wherein nanostructure precursor comprises a metal salt.

7. The method of claim 6, wherein the metal salt comprises a metal selected from the group consisting of gold, silver, platinum, palladium, iron, cadmium, and combinations and metal alloys thereof.

8. The method of claim 6, wherein the metal salt is selected from the group consisting of HAuCl₄, Na₂PtCl₄, CdCl₂, ZnCl₂, FeCl₃, and NiCl₂.

9. The method of claim 1, wherein the block copolymer matrix comprises PEO-b-P2VP, the nanostructure precursor comprises HAuCl₄, and the ink comprises an about 1:1 to about 10:1 molar ratio of P2VP: Au.

10. The method of claim 1, comprising reducing the metal salt by performing a plasma treatment.

11. The method of claim 10, wherein the plasma treatment is an oxygen plasma treatment or an argon plasma treatment.

12. The method of claim 1, comprising contacting the substrate with a tip array comprising a plurality of tips, with each tip being coated in the ink.

13. The method of claim 1, comprising contacting the substrate with the tip for a period of time of about 0.01 seconds to about 30 seconds.

14. The method of claim 1, comprising contacting the substrate for a first contacting period of time and further comprising moving the tip, the substrate, or both, and repeating the contacting step for a second contacting period of time.

15. The method of claim 14, wherein the first and second contacting periods of time arc different.

16. The method of claim 1, wherein the printed feature comprises block copolymer matrix micelles having the nanostructure precursor contained therein.

17. The method of claim 1, wherein the printed features have a diameter (or line width) of about 20 nm to about 1000 nm.

18. The method of claim 1, further comprising removing the block copolymer matrix after reducing the nanostructure precursor in the printed feature.

19. The method of claim 1, comprising removing the block copolymer matrix by performing a plasma treatment.

20. The method of claim 1, wherein the nanostructure is a nanoparticle.

21. The method of claim 1, wherein the tip is a tip for dip pen nanolithography.

22. The method of claim 1, wherein the tip is disposed on a cantilever.

23. The method of claim 22, wherein the tip is an atomic force microscope tip.

24. The method of claim 1, comprising contacting the substrate with at least one tip from a tip array comprising a plurality of tips fixed to a common substrate layer, the tips and the common substrate layer being formed from an elastomeric polymer or elastomeric gel polymer, and the tips having a radius of curvature of less than about 1 μm.

25. A method for forming a sub-micron sized nanoparticle on a substrate surface, comprising:
contacting a substrate with a tip coated with an ink comprising PEO-b-P2VP and a metal salt to form a printed feature comprising a micelle comprising the PEO-b-P2VP and containing the metal salt; and
reducing the metal salt of the printed feature to form a nanoparticle having a diameter of less than 1 μm.
